(19) United States
(12) Patent Application Publication
(10) Pub. No.: US 2022/0398890 A1
(43) Pub. Date: Dec. 15, 2022

(54) CUP DISPENSER FOR A BEVERAGE VENDING MACHINE

(71) Applicant: EVOCA S.P.A., Milano (IT)

(72) Inventors: Dan Alexie Sirbu Villa, Milano (IT); Andrea Serenelli, Milano (IT); Alberto Crippa, Milano (IT)

(21) Appl. No.: 17/774,740

(22) PCT Filed: Nov. 12, 2020
(86) PCT No.: PCT/IB2020/060662

§ 371 Date: May 5, 2022

(30) Foreign Application Priority Data
Nov. 12, 2019 (IT) 102019000020940

(51) Int. Cl. G07F 13/10

(52) U.S. Cl. CPC G07F 13/10

(57) ABSTRACT

A cup dispenser for a beverage vending machine and comprising a cup storage designed to dispense individual cups, a cup holder designed to receive a cup by gravity from the cup storage and hold the cup in an upright position, and a cup guide device, which comprises a stationary slide and an cup intercepting device arranged along the slide and designed to interact with the cup during the descent of the cup along the slide so as to slow down, and possibly temporarily stop, the descent of the cup.

### CROSS-REFERENCE TO RELATED PATENT APPLICATIONS

This patent application claims priority to Italian Patent Application No. 102019000020940 filed on Dec. 11, 2019, the entire disclosure of which is incorporated herein by reference.

### TECHNICAL FIELD OF THE INVENTION

The present invention relates to a cup dispenser, which finds advantageous, although not exclusive, application in beverage vending machines, to which the following description will refer without thereby losing its generality.

### PRIOR ART

In the vending field it is known to arrange at least one cup dispenser in beverage vending machines generally comprising a cup storage and a cup holder designed to receive a cup from the cup storage and to hold it during filling with a beverage.

Commonly, the cup storage is in the form of a vertical turret storage, which is formed by a plurality of columns housing respective stacks of cups and is rotatable about a central axis so as to bring one column at a time to a cup releasing station, at which a cup release device normally integrated in the column separates a cup from the bottom of the stack and lets it fall in the cup holder, wherefrom, after having been filled, the cup is usually extracted manually by a consumer.

The need to dispense cups of different sizes has led the manufacturers to equip the turret storage with columns of different diameters so as to contain respective stacks of cups of different sizes, and to provide adjustable cup release devices so as to be adjustable to the size of the cups contained in the respective column.

The possibility to dispense cups of different sizes has consequently entailed the need to adjust also the cup holder so that the retaining area of the cup holder designed to circumferentially engage the cup is dimensioned to firmly hold the different types of cups. To meet this need, many solutions have been developed, among which, for example, that of giving the cup holder a suitable shape, typically funnelled, allowing it to indifferently hold cups of different sizes, or that of making the portion of the cup holder designed to enter into contact with the cup movable so as to adjust to the size of the cup to be received, or that of using different cup holders for different cup sizes and of selectively moving them to bring each time the suitable one under the cup releasing station.

Normally, after having been released from the respective stack of cups at the cup releasing station, the cup is left free to fall towards the cup holder, guiding its fall by means of a stationary slide.

Since, for bulk reasons, the cup releasing station and the inlet of the cup holder are not usually vertically mutually aligned, the slide is normally inclined so as to guide the cup and centre it as much as possible with respect to the inlet of the cup holder.

Although the use of a stationary slide for guiding the cups from the outlet of the cup storage to cup holder is an extremely simple and effective conveyance solution, the Applicant has experienced that in “multi-cup” dispensers, i.e., cup dispensers capable of dispensing cups of different sizes, malfunctions can frequently occur deriving from the fact that, since the cups have different diameters and lengths, the stationary slide does not always manage to ensure that all the cups correctly centre the cup holder beneath.

Some solutions are known in which the problem has been solved at least in part by arranging, along the stationary slide, a passive cup intercepting member, i.e., a tilting member which, in an initial rest position, extends partially through the fall path of the cup. When the cup descends along the slide, the cup intercepts the tilting member and forces it to move laterally against the thrust of elastic means, which are configured to move the tilting member back into the initial rest position, once the cup has been removed by the consumer from the support device. The function of the tilting member is to partially absorb the kinetic energy of the cup which descends along the slide so as to prevent the cup from tilting during the descent, so failing to correctly enter the cup holder.

Solutions of this type are known, for example, from U.S. Pat. Nos. 2,994,420 A, 2,472,921 A and 7,100,796 B1.

### OBJECT AND SUMMARY OF THE INVENTION

The objective of the present invention is to provide a cup dispenser for a beverage vending machine improved compared to known solutions.

According to the present invention, a cup dispenser for a beverage vending machine is provided, as claimed in the appended claims.

### BRIEF DESCRIPTION OF THE DRAWINGS

FIG. 1 shows a top perspective view of a cup dispenser for a beverage vending machine according to a preferred embodiment of the present invention.

FIGS. 2 and 3 show a detail of FIG. 1 in two different configurations.

FIGS. 4 to 7 show the steps of an operating cycle of the detail of FIG. 2.

### DETAILED DESCRIPTION OF PREFERRED EMBODIMENTS OF THE INVENTION

The present invention will now be described in detail with reference to the attached figures to enable a person skilled in the art to construct it and use it. Various modifications to the described embodiments will be immediately apparent to those skilled in the art and the general principles described can be applied to other embodiments and applications without thereby departing from the protection scope of the present invention, as defined in the appended claims. Therefore, the present invention must not be considered limited to the described and illustrated embodiments, but is intended to have the widest protection scope in accordance with the described and claimed characteristics.

Unless otherwise defined, all the technical and scientific terms used herein have the same meaning commonly used by people of ordinary skill in the field pertaining to the present invention. In the case of conflict, the present description, comprising the definitions provided, will be binding. Furthermore, the examples are provided for illustrative purposes only and as such must not be considered limiting.

To facilitate the understanding of the embodiments described herein, reference will be made to some specific embodiments and a specific language will be used to describe them. The terminology used in the present document is intended to describe only particular embodiments, and is not intended to limit the scope of the present invention.

In the attached Figures, reference numeral 1 references as a whole a cup dispenser for a beverage vending machine (not shown).

The cup dispenser 1 comprises a cup storage 2 designed to dispense individual cups 3 at a cup releasing station 4.

The cup dispenser 1 further comprises a cup holder 5 arranged under the cup storage 2 at a cup receiving station 6 to receive by gravity, at each operating cycle, a cup 3, to hold the cup 3 in an upright position during filling with the beverage or beverage ingredients, and lastly to allow a consumer to extract the filled cup 3 by transversally withdrawing it from the cup holder 5.

The cup receiving station 6, wherein the cup 3 engages the cup holder 5, also defines a cup filling station and an cup withdrawing station. In a variant, the cup filling station and/or the cup withdrawing station do not physically coincide with the cup receiving station 6, and the cup holder 5 is mounted to move between the cup receiving station 6 and the cup filling station and/or the cup withdrawing station.

In the preferred embodiment shown in the attached figures, the cup storage 2 is a vertical turret storage, preferably of the type disclosed and shown in WO 2017/158555 A1 in the name of the same Applicant, and comprises a plurality of columns 7 mounted on a carousel rotatably mounted to rotate about a fixed vertical axis. Each column 7 comprises a tubular member 8 designed to contain a respective stack of cups 3, and a cup releasing device 9, which is arranged at a lower end of an associated tubular member 8 and is operable, when arranged in the cup releasing station 4, to release an individual cup 3 from the bottom of the relative stack and letting it free to fall downwards.

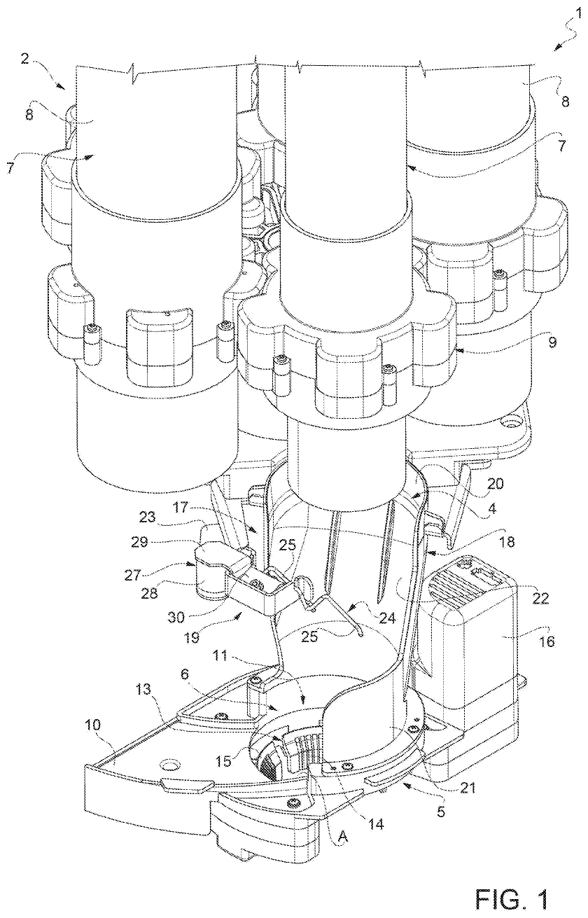

As shown in FIG. 1, the tubular members 8 have equal or different diameters so as to be able to contain cups 3 of different sizes. The cup releasing devices 9 are suitably dimensioned according to the size of the cups 3 contained in the respective column 7.

The cup holder 5 comprises a frame 10 wherein a cup falling channel 11 is formed, which extends along a vertical axis 12, defines the cup receiving station 6 and has, at least at a lower terminal end, a lateral opening, preferably about 90° wide, designed to allow the extraction of the cup 3 by a consumer.

The cup holder 5 further comprises a cup retaining device arranged in the cup falling channel 11, conveniently at an outlet thereof, and comprising a plurality of cup retaining members 13, which are distributed, preferably uniformly mutually spaced apart, along an arch, conveniently about 270° wide, so as to mutually define a retaining area A coaxial to the axis 12 and designed to be occupied by a cup 3 when it is arranged between the cup retaining members 13. The ends of the arch formed by the cup retaining members 13 delimit an opening, which is arranged facing, and has a width approximately corresponding to, the longitudinal opening of the cup falling channel 11 so as to allow extraction of the filled cup 3 transversally to the axis 12.

In the preferred embodiment shown in the attached figures, the cup retaining members 13 are mounted on the frame 10 so as to be movable in respective radial directions relatively to the axis 12 so as to allow the cup retaining area A to be widened and reduced based on the size of the cup 3 to be retained.

For this purpose, each cup retaining member 13 comprises a cup engagement portion 14 which is curvilinear and delimits, with the other cup engagement portions 14, the cup retaining area A, and a slider 15, which extends in radial direction with respect to the axis 12 and slidably engages a respective track (not shown) in the frame 10 to guide the respective cup retaining member 13 during adjustment of the size of the cup retaining area A.

The cup retaining members 13 are operable simultaneously via a mechanical transmission (not shown) arranged in the frame 10 and designed to transform a rotatory motion of an output shaft of an electric actuator 16 mounted on the frame 10 in a linear motion of the cup retaining members 13 in the respective radial directions.

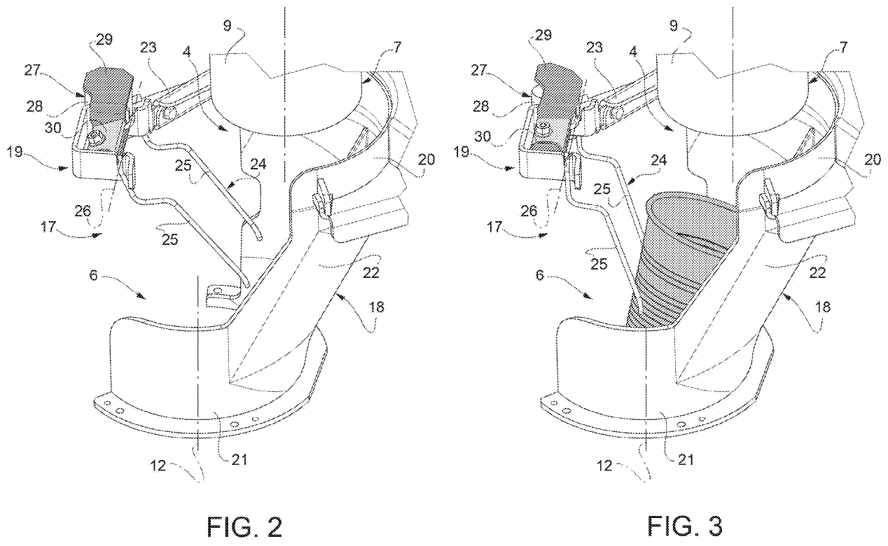

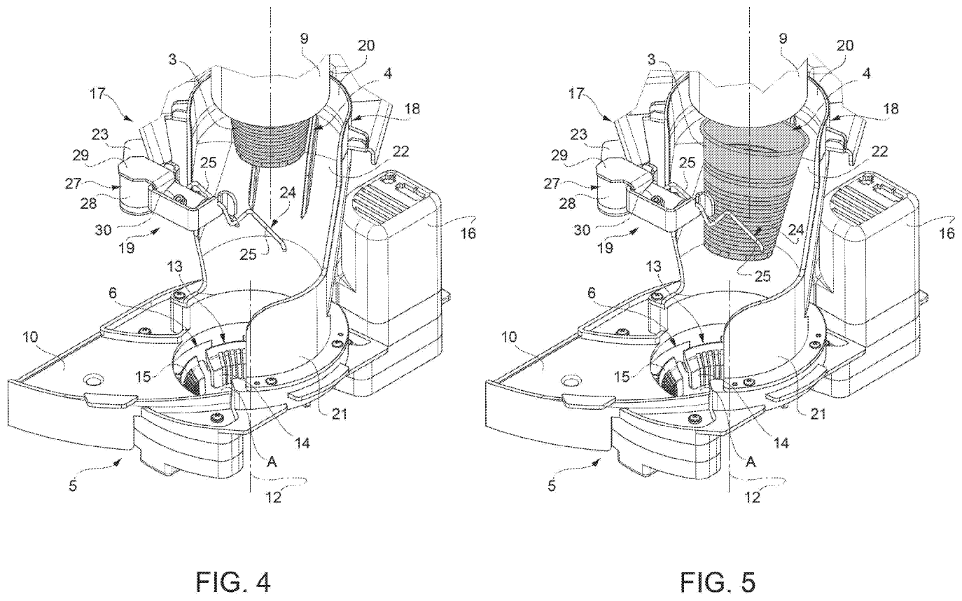

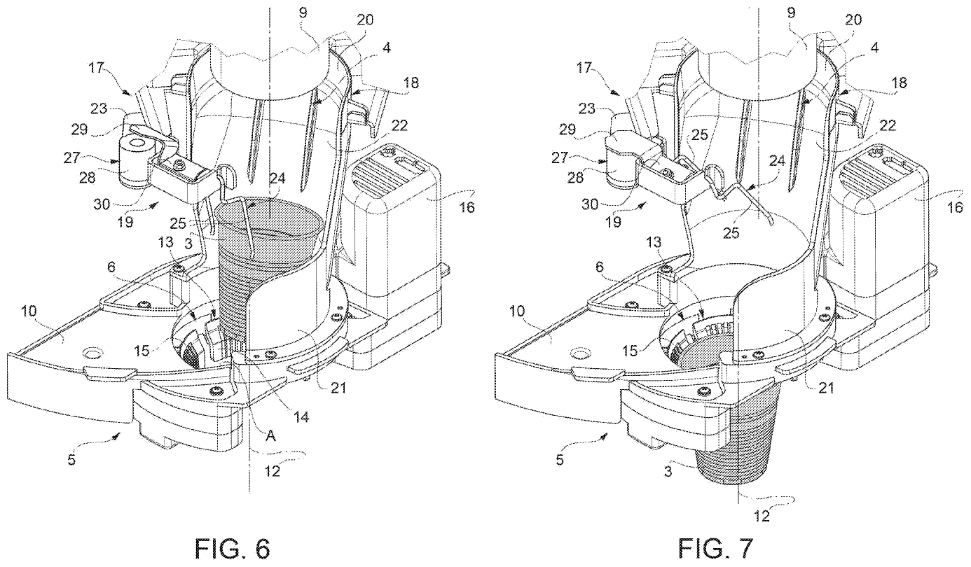

As shown in FIG. 1 and in greater detail in FIGS. 2 and 3, the cup dispenser 1 further comprises a cup guide device 17 having the function to receive, during operation, a cup 3 dispensed from a column 7 in the cup releasing station 4 and to guide the fall thereof up to the cup receiving station 6 so that the cup 3 reaches the inlet of the cup falling channel 11 in a substantially upright position and as much as possible centred with respect to the axis 12 and, hence, to the cup retaining area A.

The cup guide device 17 comprises a slide 18, which extends in fixed position between the cup releasing station 4 and the cup receiving station 6, and a cup intercepting device 19 arranged along the slide 18 and designed to act on the cup 3 when the latter falls along the slide 18 so as to slow down, and possibly temporarily stop, the fall of the cup 3.

Furthermore, the cup intercepting device 19 is designed, when interacting with the cup 3, to position, and possibly reposition, the cup 3 correctly with respect to the slide 18 so as to cause the cup 3 to be centred with respect to the inlet of the cup holder 5, so preventing the cup 3 from failing to correctly insert between the cup retaining members 13.

Preferably, the slide 18 is supported by the frame 10, has a general semi-funnel shape and comprises an upper inlet portion 20, which is arranged in the cup releasing station 4 and is vertically aligned with the outlet of the column 7 which currently occupies the cup releasing station 4, and a lower outlet portion 21, which is connected to the upper inlet portion 20 via a concave inclined wall 22, is arranged in the cup receiving station 6 so as to be vertically offset with respect to the upper inlet portion 20, and surrounds at least partially the inlet of the cup falling channel 11.

The cup intercepting device 19 is arranged under the cup releasing station 4 and is supported by a mounting bracket 23, which can be fixedly mounted either to a fixed part of the cup storage 2, as in the shown example, or, in variants not shown, to any other fixed part of the beverage vending machine.

The cup intercepting device 19 comprises a cup intercepting or slowing-down member 24 which extends towards the inside of the slide 18 and is movable, under the thrust of the cup 3 which descends along the slide 18, between a normal barrier position (FIG. 2), in which the cup intercepting member 24 extends at least partially through the path of the cup 3 along the slide 18 so as to intercept the cup 3, and a disengagement position, in which the cup intercepting member 24 is moved downwards and towards the cup holder 5 (FIG. 3) and stops accompanying the descent of the cup 3, which disengages from the cup intercepting member 24.

The cup intercepting member 24 is configured to normally maintain, i.e., when no external force acts thereon, the barrier position, to move from the barrier position to the disengagement position under the thrust of a cup 3 falling along the slide 18, and to autonomously move back into the barrier position after having reached the disengagement position and no longer being acted on by the cup 3.

The cup intercepting member 24 is sized to intercept a cup 3 of any size which can be dispensed by the cup storage 2 and to exert on the dispensed cup 3 a slowing-down and controlled accompanying action during the fall.

The cup intercepting device 19 further comprises an actuator 27, which is supported by the mounting bracket 23 and is operable to lock the cup intercepting member 24 in the barrier position so as to cause the cup intercepting member 24 not only to slow down, but also to temporarily stop, the fall of the intercepted cup 3.

In the preferred embodiment shown, the cup intercepting member 24 is in the form of a rocker arm, which is mounted to rotate about a fixed axis 26, preferably horizontal, and comprises a first arm defined by a pair of rods 25, which are formed by a U-shaped fork, are mutually connected by a crossbar (not shown in the Figures), and rotatably engage respective slots in the mounting bracket 23 and defining a rotating hinge of the rocker arm.

The rocker arm further comprises a second arm opposing the rods 25 and formed by the part of fork containing the crossbar and by a plate 29 made of conductive material, integral to the pair of rods 25, and the function of which will be described here below.

As shown in FIG. 2, in the barrier position, the two rods 25 extend transversally inside the slide 18 and their dimension and mutual distance are such that, when a cup 3 of any size is released from the respective column 7 and starts descending along the slide 18, the conical body of the cup 3 partially inserts, in a larger or smaller extent depending on the size of the cup 3, in the space comprised between the rods 25.

As shown in FIG. 3, in the disengagement position, the rods 25 are rotated downwards by the thrust exerted on the rods 25 by the cup 3 which, sliding downwards, progressively moves the rods 25 away from the slide 18 up to completely disengage from the rods 25.

The actuator 27 can be of any type as long as it is suitable to temporarily lock the cup intercepting member 24 in the barrier position, i.e., to lock the cup intercepting member 24 with a retaining force greater than the downward thrust exerted on the rods 25 by the cup 3. Conveniently, the actuator 27 is of an electromagnetic type and comprises an electromagnet 28 designed to interact with the plate 29.

In particular, as shown in FIGS. 2 and 3, in the normal barrier position, the plate 29 is arranged in contact with the electromagnet 28, while in the disengagement position, the plate 29 is detached from the electromagnet 28 and rotated upwards, with respect to the barrier position.

If, in the barrier position, the electromagnet 28 is electrically powered before the rods 25 intercept a cup 3, the electromagnet 28 retains the plate 29, thus locking the entire cup intercepting member 24 in the barrier position and thus preventing the rods 25 from rotating downwards when engaged by the cup 3.

The electromagnet 28 is maintained electrically powered for the time strictly necessary to stop the cup 3, after which it is electrically de-powered so as to leave the cup intercepting member 24 free to rotate about the axis 26 under the thrust of the cup 3 and accompany the cup 3, while controlling the fall thereof, up to when the cup 3 abandons the rods 25.

The capacity of the cup intercepting member 24 to maintain, when no external force acts thereon, the barrier position and to return, at the end of the force acted thereon by the cup 3, from the disengagement position to the barrier position is the result of a suitable distribution of the masses of the cup intercepting member 24. In particular, the second arm of the rocker arm/cup intercepting member 24, i.e., the part of the cup intercepting member 24 which is opposed to the rods 25 with respect to the axis 26 and comprises the plate 29, has a greater weight than the first arm of the rocker arm, i.e., the rods 25. This greater weight can be obtained by using a plate 29 of suitable weight or, as in the example shown, by providing the plate 29 with a counterweight 30.

The weight of the second arm of the rocker arm determines the resistance opposed by the cup intercepting member 24 to the rotation about the axis 26 under the thrust of the cup 3 and is chosen by keeping into account, on the one hand, cups 3 larger in size and weight, so that the cup intercepting member 24 is capable of suitably decreasing the fall of the cup 3 and controllably accompanying the descent thereof, and, on the other hand, cups 3 smaller in size and weight, so that the resistance offered by the cup intercepting member 24 fails to exceed the thrust exerted by the cup 3 on the rods 25.

In a variant, in replacement or in addition to the solution described above to ensure the stability and the return of the rods 25 in the barrier position, an elastic return member can be provided, for example a spring.

Conveniently, during operation, the electromagnet 28 is electrically powered to temporarily lock the cup intercepting member 24 when a cup 3 of small size is dispensed. In this case, in fact, due to the reduced dimensions and weight of the cup 3, the risk that the cup 3 may assume incorrect positions during the fall is greater. By temporarily stopping the cup 3 and then accompanying it in the descent along the slide 18, a greater control of the fall of the cup 3 is obtained compared to the case where the fall of the cup 3 is accompanied only by the cup intercepting member 24 without ever being stopped.

Figures from 4 to 7 schematically show four steps of a cup dispensing cycle. The operation of the cup dispenser 1 is clearly deducible from what presented above and fails to require further explanations.

1-9. (canceled)

10. A cup dispenser for a beverage vending machine, the cup dispenser comprising:
a cup storage to dispense individual cups;
a cup holder to receive a cup by gravity from the cup storage and hold the cup in an upright position;
a cup guide device to control the cup during fall from the cup storage to the cup holder and including a stationary slide; the cup guide device further including a cup intercepting device arranged to interact with the cup during descent of the cup along the stationary slide and including a cup intercepting member mounted to move from and to a barrier position, in which the cup intercepting member extends at least partially through a path of the cup along the stationary slide to intercept the cup during the descent of the cup along the s stationary slide; and
an actuator coupled to the cup intercepting device and operable to temporarily lock the cup intercepting member in the barrier position before the cup intercepting member intercepts the cup so as to temporarily stop the descent of the cup.

11. The cup dispenser of claim 10, wherein the cup intercepting member is configured to support the cup in a substantially upright position when the cup intercepting member is temporarily locked in the barrier position.

12. The cup dispenser of claim 11, wherein the cup intercepting device is mounted to move from the barrier position to a disengagement position under thrust of a weight of the cup descending along the stationary slide; the cup intercepting member is configured to accompany the descent of the cup while the cup intercepting member moves from the barrier position to the disengagement position so as to maintain the cup in a substantially upright position and cause it to descend at a speed lower than a freefall speed, and to completely release the cup when the disengagement position is reached and the cup is inserted in the cup holder.

13. The cup dispenser of claim 12, wherein the cup intercepting member is designed to normally maintain the barrier position when no external force acts thereon and to move back to the barrier position after the disengagement position is reached and being no longer engaged by the cup.

14. The cup dispenser of claim 12, wherein the cup intercepting member includes a rocker arm mounted to rotate about a stationary axis and including a first fork-shaped arm with a pair of rods so mutually spaced apart as to cause a bottom portion of a cup released from the cup storage to at least partially enter between the rods and rest thereon when the cup intercepting member is in the barrier position.

15. The cup dispenser of claim 14, wherein, in the disengagement position of the cup intercepting member, the rods are rotated downwards with respect to the barrier position.

16. The cup dispenser of claim 15, wherein the rocker arm includes a second arm opposing the first arm and acting as a counterweight to normally maintain the cup intercepting member in the barrier position and to bring the cup intercepting member from the disengagement position back to the barrier position.

17. The cup dispenser of claim 10, wherein the actuator includes an electromagnet electrically powerable to temporarily lock the cup intercepting member in the barrier position and electrically de-powerable to leave the cup intercepting member free to move away from the barrier position under the thrust of the cup.

18. The cup dispenser of claim 10, wherein the cup storage is configured to dispense cups of different sizes.
